(19) United States
(12) Patent Application Publication
(10) Pub. No.: US 2026/0116734 A1
(43) Pub. Date: Apr. 30, 2026

(54) APPARATUS OF SUPPLYING FROSTED BEER AGED AT LOW TEMPERATURE

(71) Applicant: wevelopment Co., Ltd., Gyeonggi-do (KR)

(72) Inventor: Seung Min JUNG

(21) Appl. No.: 19/021,218

(22) Filed: Jan. 15, 2025

(30) Foreign Application Priority Data
Oct. 29, 2024 (KR) 10-2024-0149601

(51) Int. Cl. B67D 1/08; B67D 1/00

(52) U.S. Cl. CPC B67D 1/0884; B67D 1/0081; B67D 1/0857

(57) ABSTRACT

An apparatus of supplying frosted beer aged at low temperature includes a walk-in freezer storing a draft beer container and a plurality of beer supply nozzles connected to the draft beer container and a beer supply pipe. A first beer supply nozzle in the plurality of the beer supply nozzles supplies beer toward a lower face of a beer glass. A second beer supply nozzle in the plurality of the beer supply nozzles supplies beer toward an inner face of the beer glass. The apparatus may supply frosted beer without a separate cooler connected to the draft beer container and enhance taste of the beer through aging.

### CROSS-REFERENCE TO RELATED APPLICATION

This application claims, under 35 U.S.C. § 119 (a), the benefit of and priority to Korean Patent Application No. 10-2024-0149601, filed Oct. 29, 2024, the entire contents of which are incorporated herein by reference.

### BACKGROUND

### Technical Field

The present invention relates to an apparatus of supplying frosted beer aged at low temperature and, more specifically, to an apparatus of supplying frosted beer aged at low temperature that can supply frosted beer without separate cooling and enhance the taste of the beer through aging.

### Background Art

Generally, beer is a frothy flavorful alcoholic beverage. For example, beer refers to an alcoholic beverage made by saccharifying barely by mashing and adding hops therein to be fermented by yeast. Beer has long been a popular and familiar drink relished by people of all ages and genders as having a relatively low alcoholic percentage and easily accessible aspect. Consumption patterns of beer based on such popular preferences show that bottled or canned beers can be easily purchased and consumed at any places, such as home, outdoors, and stores, due to its handy distribution aspect, as described above. On the other hand, draft beers are shown to be generally purchased and consumed at a draught beer specialty store since draft beers require designated essential elements, such as a storage device, a dispenser, and the like.

According to the prior art, the designated essential elements may comprise a keg for storing draft beer, a gas tank filled with compressed gas (CO₂), a connecting cap sealingly coupled at an open inlet of a storage tank, a dispenser for dispensing the draft beer stored in the storage tank through a beer supply pipe extending from the connecting cap, and a cooler installed on a pipe of the beer supply pipe for rapidly cooling the draft beer supplied into the beer supply pipe.

In this conventional technology, the keg storing the draft beer and the cooler cooling the beer supplied from the keg are separately provided. Accordingly, the keg kept at room temperature may cause the draft beer to be spoiled or degraded. Furthermore, since the beer temporarily cooled by the cooler is served, causing carbon content in the beer to be improper, carbonation taste or flavor tends to decrease.

### SUMMARY

An embodiment of the present invention is to provide an apparatus of supplying frosted beer aged at low temperature that may supply frosted beer without a separate cooler.

In an aspect, an apparatus of supplying frosted beer aged at low temperature according to an embodiment of the present invention comprises a walk-in freezer including an internal space therein and configured to accommodate a draft beer container in the internal space, a first controller configured to control an internal temperature of the walk-in freezer, a gas supply portion connected to the draft beer container and configured to supply carbon dioxide to the draft beer container, and a plurality of beer supply nozzles disposed at an outer side of the walk-in freezer and connected to the draft beer container and a beer supply pipe. A first beer supply nozzle in the plurality of the beer supply nozzles may be configured to supply a beer from the draft beer container toward a lower face of a beer glass. A second beer supply nozzle in the plurality of the beer supply nozzles may be configured to supply the beer from the draft beer container toward an inner face of the beer glass.

In an embodiment, the first beer supply nozzle may include a housing connected to the beer supply pipe and a plurality of distribution plates disposed inside the housing and including a plurality of through holes.

In an embodiment, the plurality of the distribution plates may be arranged to vertically face each other.

In an embodiment, the second beer supply nozzle may include a main injection portion configured to communicate with the beer supply pipe and a plurality of auxiliary injection portions configured to communicate with at least one of the beer supply pipe or the main injection portion and surround the main injection portion.

In an embodiment, the plurality of auxiliary injection portions may include an auxiliary injection nozzle configured to direct the beer and an angle adjustment module configured to adjust an injection angle of the auxiliary injection nozzle.

In an embodiment, the first beer supply nozzle may be configured to primarily supply the beer to the beer glass, and the second beer supply nozzle may be configured to secondarily supply the beer to the beer glass.

According to the present invention, frosted beer can be supplied without a separate cooler that freezes beer supplied through a beer supply nozzle.

Also, according to the present invention, beer with little foam can be provided.

In addition, according to the present invention, beer with improved taste can be provided since the beer is cooled to a predetermined temperature by a walk-in freezer and aged by supplying carbon at a predetermined pressure through a gas supply portion.

### BRIEF DESCRIPTION OF THE DRAWINGS

FIG. 1 is a view schematically illustrating an apparatus of supplying frosted beer aged at low temperature according to an embodiment of the present invention;

FIG. 2 is a view schematically illustrating a beer glass freezer according to an embodiment of the present invention;

FIG. 3 is a view schematically illustrating a setting portion according to an embodiment of the present invention;

FIG. 4 is a schematic view of a foam removal module connected to a beer supply pipe of FIG. 1;

FIG. 5 is a schematic view of an embodiment of the foam removal module depicted in FIG. 4;

FIG. 6 is a view schematically illustrating a first beer supply nozzle depicted in FIG. 1;

FIG. 7 is a view schematically illustrating a distribution plate depicted in FIG. 6;

FIG. 8 is a view schematically illustrating an embodiment of the distribution plate depicted in FIG. 7;

FIG. 9 is a view schematically illustrating a second beer supply nozzle depicted in FIG. 1; and

FIG. 10 is a view schematically illustrating a cold wind supply module according to an embodiment of the present invention.

### DETAILED DESCRIPTION

Throughout the specification, the same reference numerals refer to substantially identical components. In the following description, a detailed description regarding elements not related to core elements of the present invention and elements and functions known in the technical field to which the present invention belong may be omitted. The meaning of terms as used herein may be understood as follows.

The advantages and features of the present invention and the method for achieving them will become clear by referring to embodiments described in detail below together with the accompanying drawings. However, the present invention is not limited to the embodiments disclosed below but may be implemented in various forms. The embodiments are merely provided to make the present disclosure complete and to fully explain the scope of the invention to one having ordinary skill in the technical field to which the present invention belongs. The present invention may be only defined by the scope of the claims.

The shapes, sizes, ratios, angles, numbers, and the like, illustrated in the drawings for explaining the embodiments of the present invention, are exemplary. Therefore, the present invention is not limited to the illustrations in the drawings. The same reference numerals refer to the same components throughout the specification. Additionally, in describing the present invention, if it is determined that a detailed description regarding related known technology may unnecessarily obscure the gist of the present invention, the detailed description thereof will be omitted.

In case where expressions, such as ‘include,’ ‘have,’ ‘be made of,’ etc., are used in the present specification, other parts may be added unless ‘only’ is used. When a component is expressed in a singular form, the component may also be provided in plural unless there is a special explicit description.

In interpreting a component, it is interpreted as including an error range of the component even without a separate explicit description.

In describing a positional relationship between two portions, e.g., ‘on,’ ‘above,’ ‘below,’ ‘next to,’ etc., one or more other portions may be located between the two portions unless ‘right’ or ‘directly’ is used.

In describing a temporal relationship, e.g., when the temporal chronological relationship is described using ‘after,’ ‘subsequently,’ ‘next to’, ‘before,’ etc., it may include cases where it is not continuous unless ‘right’ or ‘directly’ is used.

Although terms, such as first, second, or the like, are used to describe various components, these components are not limited by these terms. These terms are used only to distinguish one component from another. Accordingly, the first component mentioned below may also be the second component within the technical scope of the present invention.

“X-axis direction,” “y-axis direction,” and “z-axis direction” should not be interpreted as a geometric relationship in which the relationship between each other is perpendicular but may mean a wider directionality within the range on which the configuration of the present invention can functionally act.

The term “at least one” should be understood to include all combinations that can be presented from one or more related items. For instance, the meaning of “at least one of a first item, a second item, or a third item” may mean not only the first item, the second item or the third item but also all combinations of items that can be selected from two or more of the first item, the second item, or the third item.

Each feature in various embodiments of the present invention may be partially or entirely coupled or combined with each other. Various technical connections and operations are possible, and each embodiment may be implemented independently of each other or may be implemented together in association with each other.

Hereinafter, an apparatus 1 of supplying frosted beer aged at low temperature according to an embodiment of the present invention is described with reference to the drawings.

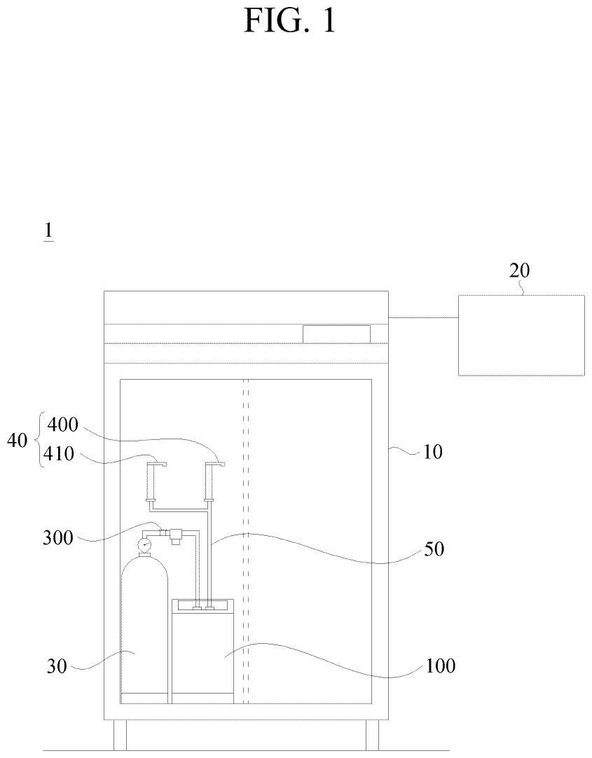

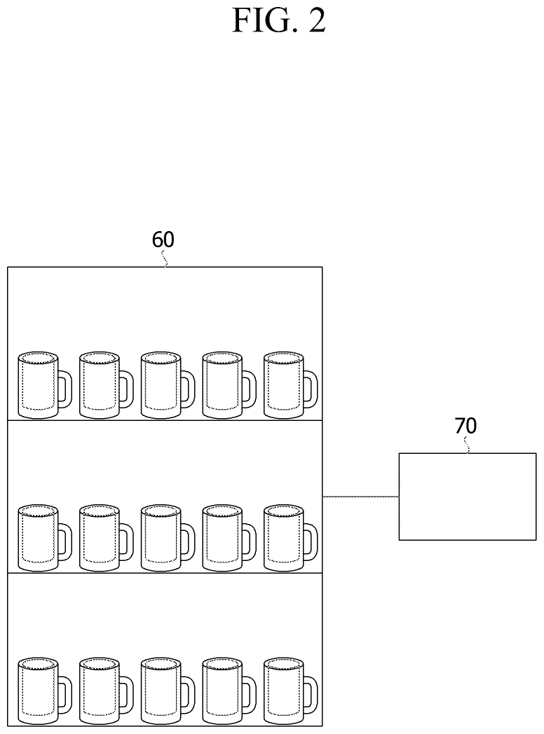

FIG. 1 is a view schematically illustrating the apparatus 1 of supplying frosted beer aged at low temperature (cold-fermented) according to an embodiment of the present invention, and FIG. 2 is a view schematically illustrating a beer glass freezer 60 according to an embodiment of the present invention.

Referring to FIGS. 1 and 2, the apparatus 1 of supplying frosted beer aged at low temperature according to an embodiment of the present invention comprises a walk-in freezer 10, a first controller 20, a gas supply portion 30, a beer supply nozzle 40, and a beer supply pipe 50.

The walk-in freezer 10 may have an internal space. The walk-in freezer 10 may accommodate a draft beer container 100 in the internal space. The walk-in freezer 10 may store a plurality of draft beer containers 100. The first controller 20 is configured to control an internal temperature of the walk-in freezer 10. The gas supply portion 30 may be connected to the draft beer container 100. The gas supply portion 30 may supply carbon dioxide to the draft beer container 100. The beer supply nozzle 40 may be arranged on the outside of the walk-in freezer 10. The beer supply pipe 50 may be connected to the beer supply nozzle 40 and the draft beer container 100.

In one embodiment, the walk-in freezer 10 may include a panel housing. In an embodiment, the panel housing may be formed of urethane. The walk-in freezer 10 may include a door. In an embodiment, the walk-in freezer 10 may include at least one door. In an embodiment, the walk-in freezer 100 may include a plurality of doors. Also, the door may be an overlapping door (top-mounted), a single-slide door (automatic/manual), or a double-slide door (automatic/manual). In addition, the walk-in freezer 10 may include a unit cooler. The unit cooler may supply cooled air to the internal space of the walk-in freezer 10.

The gas supply portion 30 is configured to supply carbon dioxide to the draft beer container 100. In this respect, the draft beer container 100 may have a predetermined internal pressure. Accordingly, the beer contained in the draft beer container 100 may have a predetermined carbonation saturation. The beer may have carbonation taste. Also, due to the gas pressure supplied by the gas supply portion 30, the beer may flow from the draft beer container 100 toward the beer supply nozzle 40. However, the present invention is not limited thereto, and other techniques that can discharge the beer from the draft beer container 100 may be utilized. The gas supply portion 30 may include a control valve 300. The control valve 300 may control the amount of gas supplied from the gas supply portion 30 to the draft beer container 100.

The beer supply nozzle 40 may extend or may be drawn outwardly from an outer face of the walk-in freezer 10. The beer supply nozzle 40 may further include a lever (not shown). Supplying or stopping supply of the beer by the beer supply nozzle 40 may be determined by the lever. The beer supply pipe 50 may guide a flow of the beer flowing out of the draft beer container 100 toward the beer supply nozzle 40.

The apparatus 1 of supplying frosted beer aged at low temperature according to one embodiment of the present invention may further include the beer glass freezer 60 and a second controller 70. The beer glass freezer 60 may freeze beer glasses. A plurality of beer glasses may be accommodated in the beer glass freezer 60. In an embodiment, the beer glasses may be frozen for 12 hours in the beer glass freezer 60. The second controller 70 may control the internal temperature of the beer glass freezer 60.

In one embodiment, the second controller 70 may control the internal temperature of the beer glass freezer 60 to minus 40 degrees Celsius (° C.). Moreover, in an embodiment, the first controller 20 may control the internal temperature of the walk-in freezer 10 between −1° C. and plus 2° C. The first controller 20 may adjust the internal temperature of the walk-in freezer 10 according to the ambient temperature of the walk-in freezer 10 and the beer glass freezer 60. An experiment was conducted by setting the temperature of the beer to 0° C. and decreasing the temperature of the beer glass from −10° C. to −40° C. by an increment of 5° C. When the temperature of the beer glass is between −10° C. and −20° C., the beer does not sufficiently freeze on the surface of the beer glass and thus does not well separate from the surface of the beer glass. When the temperature of the beer glass is between −20° C. and −35° C., some of the beer separates from the surface of the beer glass and floats on top of the beer in the beer glass. When the temperature of the beer glass is −40° C., frosts formed on the entire surface of the beer glass separate from the beer glass and float on top of the beer in the beer glass, providing cool and pleasant taste.

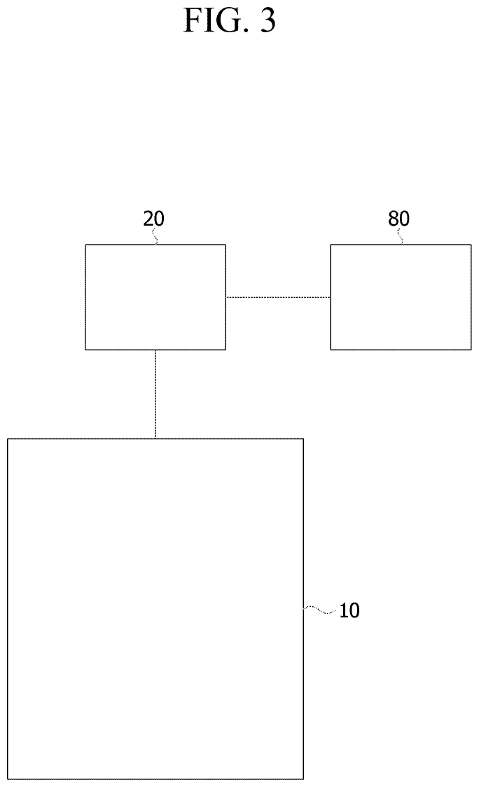

FIG. 3 is a view schematically illustrating a setting portion 80 according to an embodiment of the present invention.

Referring to FIG. 3, the apparatus 1 of supplying frosted beer aged at low temperature according to an embodiment of the present invention may further include the setting portion 80. The setting portion 80 may set the internal temperature of the walk-in freezer 10. In an embodiment, the setting portion 80 may set the internal temperature of the walk-in freezer 10 to a first set temperature or a second set temperature. The first controller 20 may control the internal temperature of the walk-in freezer 10 between 1° C. and 2° C. according to the first set temperature. Also, the first controller 20 may control the internal temperature of the walk-in freezer 10 between −1° C. and 1° C. according to the second set temperature.

The first set temperature and the second set temperature may be set by the setting portion 80 depending on the season. For instance, the first set temperature may correspond to winter, and the second set temperature may correspond to summer. In the summer, the internal temperature of the walk-in freezer 10 may be controlled to a range of −1° C. and 1° C. This allows frost or ice to be well formed throughout the surface of a beer glass when beer is poured into the beer glass such that a sufficient amount of frost can float on top of the beer contained in the beer glass. On the other hand, in the winter, even if the internal temperature of the walk-in freezer 10 is controlled in a range of 1° C. and 2° C., frost or ice may be generally well formed on the surface of the beer glass by the beer, enabling a sufficient amount of frost or ice to float on top of the beer in the beer glass. This may also reduce power consumption. If the internal temperature of the walk-in freezer 10 reaches below −1° C., the draft beer container 100 may freeze, resulting in danger, such as damage, etc. In this respect, the internal temperature of the walk-in freezer 10 may be controlled to secure frost formation performance and save power and controlled to a temperature above the temperature at which the draft beer container 100 does not freeze to prevent danger.

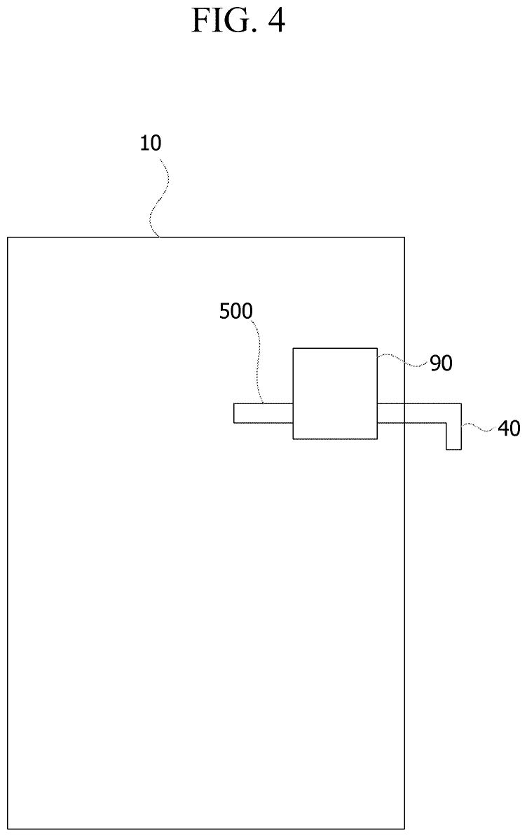

FIG. 4 is a schematic view of a foam removal module 90 connected to the beer supply pipe 50 of FIG. 1.

Referring to FIG. 4, the apparatus 1 of supplying frosted beer aged at low temperature according to an embodiment of the present invention may further include the foam removal module 90. The foam removal module 90 may be connected to the beer supply pipe 50 upstream of the beer supply nozzle 40. The foam removal module 90 may remove foam generated in the beer supplied from the draft beer container 100.

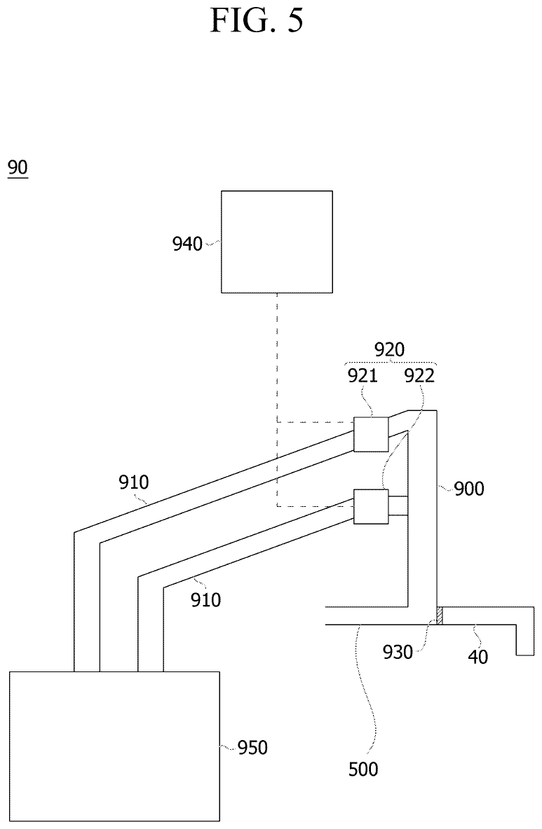

FIG. 5 is a schematic view of an embodiment of the foam removal module 90 depicted in FIG. 4.

Referring to FIGS. 4 and 5, the foam removal module 90 may include a collection pipe 900 and a discharge valve 920. Also, the beer supply nozzle 40 may have an inlet and an outlet. The beer supply pipe 50 may include an extension pipe 500. The extension pipe 500 may extend from the inlet of the beer supply nozzle 40 toward the inside of the walk-in freezer 10. In other words, at least one of the beer supply nozzle 40 or the extension pipe 500 may pass through the housing of the walk-in freezer 10.

The collection pipe 900 may be connected to the extension pipe 500. The collection pipe 900 may collect foam in the beer. To this end, the collection pipe 900 may be extended from the extension pipe 500 to an upper portion of the extension pipe 500. Accordingly, foam generated due to a temperature rise, etc., around the beer supply nozzle 40 may move to an upper portion of the collection pipe 900 along a longitudinal direction of the collection pipe 900 to be collected. At least a portion of the collection pipe 900 may be positioned above the inlet of the beer supply nozzle 40. The discharge valve 920 may be operable to open or close. Thus, the discharge valve 920 may discharge the foam, etc., collected in the collection pipe 900. The inlet of the beer supply nozzle 40 may be placed at an inner side of the walk-in freezer 10, and the outlet of the beer supply nozzle 40 may be placed at an outer side of the walk-in freezer 10.

The foam removal module 90 may further include an inclined pipe 910, a screen net 930, a third controller 940, and a collection tank 950. The collection tank 950 may be placed inside the walk-in freezer 10. The inclined pipe 910 may be arranged to be inclined from the discharge valve 920 toward a lower face of the walk-in freezer 10. Thereby, beer foam or the like discharged from the discharge valve 920 may enter the collection tank 950 along the inclined pipe 910. The beer collected in the collection tank 950 may be reused.

The screen net 930 may be disposed between the collection pipe 900 and the beer supply nozzle 40. The screen net 930 may be a mesh net including a plurality of through-holes. Accordingly, foam or the like filtered by the screen net 930 may be directed upward along the collection pipe 900 to be collected. The third controller 940 may drive opening or closing of the discharge valve 920. The third controller 940 may open the discharge valve 920 while there is no flow of beer.

The discharge valve 920 may include a first discharge valve 921 and a second discharge valve 922. The first discharge valve 921 may be connected to an upper end of the collection pipe 900. The second discharge valve 922 may be connected to the collection pipe 900 below the first discharge valve 921. Thus, when a large amount of foam or the like are collected, the foam or the like may be discharged through the second discharge valve 922.

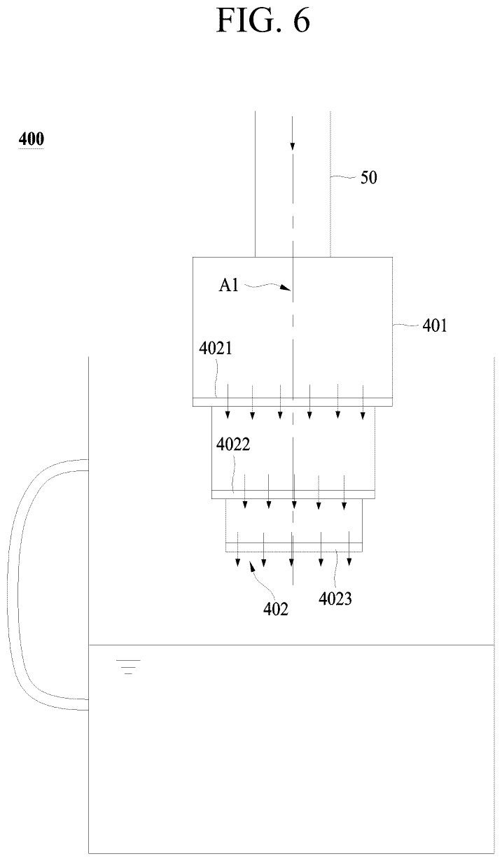

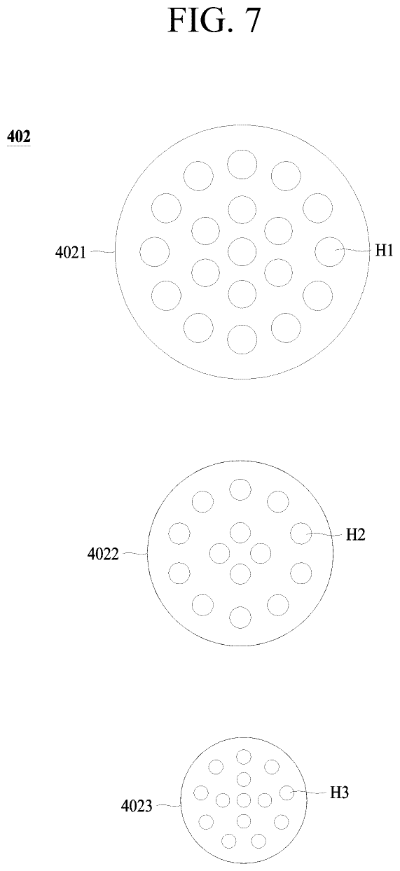

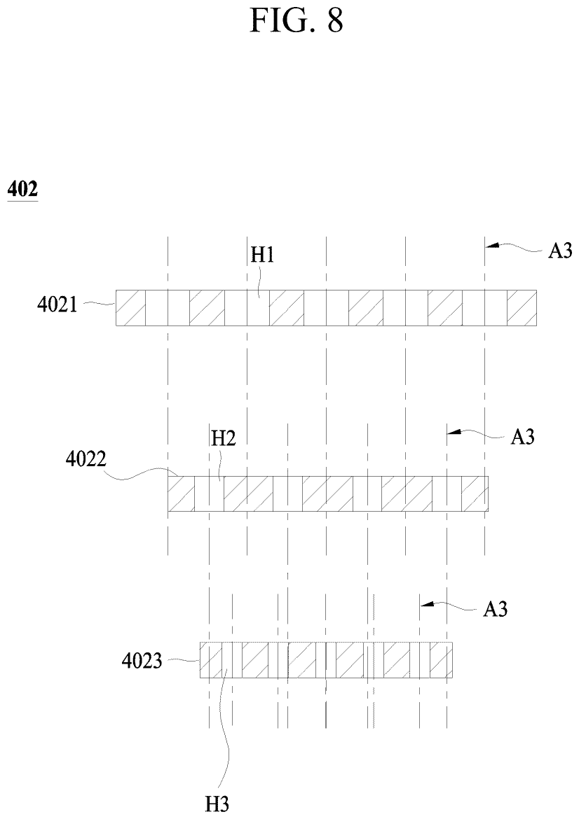

FIG. 6 is a view schematically illustrating a first beer supply nozzle 400 depicted in FIG. 1, FIG. 7 is a view schematically illustrating a distribution plate 402 depicted in FIG. 6, and FIG. 8 is a view schematically illustrating an embodiment of the distribution plate 402 depicted in FIG. 7.

Referring to FIG. 1, FIG. 6, FIG. 7 and FIG. 8, the beer supply nozzle 40 according to one embodiment of the present invention may include the first beer supply nozzle 400 and a second beer supply nozzle 410. The first beer supply nozzle 400 and the second beer supply nozzle 410 may extend from the inside of the walk-in freezer 10 to the outside of the walk-in freezer 10. The first beer supply nozzle 400 in a plurality of beer supply nozzles 40 may supply the beer toward a bottom of the beer glass. The second beer supply nozzle 410 in the plurality of beer supply nozzles 40 may supply the beer toward the inner side of the beer glass.

The first beer supply nozzle 400 may include a housing 401 and the distribution plate 402. The housing 401 may be connected to the beer supply pipe 50. The housing 401 may extend in a circumferential direction thereof with respect to a central axis (A1). The housing 401 may have different inner diameters in a direction from the top of the housing 401 to the bottom of the housing 401. For example, the housing 401 may include a first housing portion having a first inner diameter, a second housing portion having a second inner diameter smaller than the first inner diameter, and a third housing portion having a third inner diameter smaller than the second inner diameter.

The distribution plate 40 may be disposed inside the housing 401. The distribution plate 402 may include a plurality of through-holes. The beer may be supplied through the beer supply pipe 50 and discharged through the plurality of through-holes of the distribution plate 402. The distribution plate 402 may distribute the beer across a front face of the distribution plate 402 and may suppress foam generation by reducing a supply speed of the beer.

A plurality of the distribution plates 402 may be placed. The plurality of the distribution plates 402 may be disposed to vertically face each other along the central axis (A1). Accordingly, the supply amount of the beer may be distributed multiple times by the plurality of the distribution plates 402, minimizing generation of foam. In an example, the distribution plates 402 may include a first distribution plate 4021, a second distribution plate 4022, and a third distribution plate 4023. The first distribution plate 4021 may have a first diameter corresponding to the first inner diameter. The second distribution plate 4022 may have a second diameter corresponding to the second inner diameter. The third distribution plate 4023 may have a third diameter corresponding to the third inner diameter. The beer with decreasing supply speed at each distribution plate 402 may be filled up to an upper portion of the distribution plates 402, causing the foam to ascend to the top of the distribution plate 402.

The plurality of the distribution plates 402 may include through-holes of different sizes. In an example, the first distribution plate 4021 may have a first through hole (H1).

The second distribution plate 4022 may have a second through hole H2. The third distribution plate 4023 may have a third through hole (H3). The second through hole (H1) may have a smaller size than the first through hole (H1). The third through hole (H3) may have a smaller size than the second through hole (H2). In an embodiment, the central axis (A3) of the first through hole (H1) may be spaced apart from the central axis (A3) of the second through hole (H2) in a plane. In an embodiment, the central axis (A3) of the second through hole (H2) may be spaced apart from the central axis (A3) of the third through hole (H3) in a plane. This enables the supply speed of the beer at each distribution plate 402 to be reduced and the beer to be distributed with respect to the distribution plate 402.

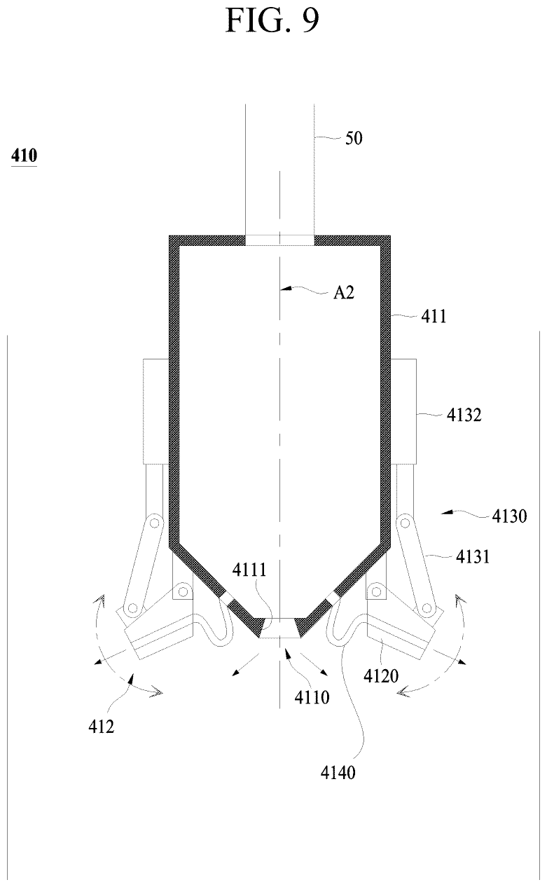

FIG. 9 is a view schematically illustrating the second beer supply nozzle 410 depicted in FIG. 1.

Referring to FIGS. 1 and 9, the second beer supply nozzle 410 may include a main injection portion 411 and an auxiliary injection portion 412. The main injection portion 411 may be in communication with the beer supply pipe 50. The main injection portion 411 may extend in a circumferential direction thereof with respect to the central axis (A2). The auxiliary injection portion 412 may communicate with at least one of the beer supply pipe 50 or the main injection portion 411. In an embodiment, a plurality of auxiliary injection portions 412 may surround the main injection portion 411. The plurality of the auxiliary injection portions 412 may be spaced apart from one another at a same angle along the circumferential direction thereof. The main injection portion 411 may direct the beer toward the bottom of the beer glass. The auxiliary injection portion 412 may direct the beer toward the inner side of the beer glass. Therefore, the beer may be formed in the form of ice or frost on the inner side of the beer glass. As the beer is gradually filled up, the ice or the frost formed on the inner side of the beer glass may float.

In one embodiment, the main injection portion 411 may include a main injection nozzle 4110. The main injection nozzle 4110 may have an inclined injection port 4111. The inclined injection port 4111 (an inner surface of the inclined injection port) may be arranged to move away from the central axis (A2) toward a lower portion of the inclined injection port 4111 along the central axis (A2). Then a portion of the beer introduced by the main injection portion 411 may be directed on the inner surface of the beer glass at the lower portion of the beer glass to form the frost or the ice. In addition, the beer glass may be rapidly filled by the main injection portion 411.

The auxiliary injection portion 412 may introduce the beer onto the inner surface of the beer glass at the upper portion of the beer glass to form frost or ice. In one embodiment, the auxiliary injection portion 412 may include an auxiliary injection nozzle 4120, an angle adjustment module 4130, and a tube 4140. The tube 4140 may be connected to the auxiliary injection nozzle 4120 to supply the beer. The tube 4140 may be connected to the main injection portion 411 or the beer supply pipe 50. The angle adjustment module 4130 may adjust an injection angle of the auxiliary injection nozzle 4120.

The angle adjustment module 4130 may include a link assembly 4131 and a driving portion 4132. The link assembly 4131 may be connected to the driving portion 4132 and the auxiliary injection nozzle 4120. The driving portion 4132 may drive the link assembly 4131. The driving portion 4132 may include a linear cylinder. The link assembly 4131 may include a plurality of links. The auxiliary injection nozzle 4120 may be rotated at a predetermined angle by the angle adjustment module 4130. Consequently, the beer may be rotated from the bottom of the beer glass toward the top of the beer glass, thereby directing the beer onto the inner surface of the beer glass. Then frost or ice may be formed up to the upper end of the inner surface of the beer glass. Also, the injection angle of the auxiliary injection nozzle 4120 may be adjusted through the auxiliary injection portion 412 based on the size of the beer glass.

The first beer supply nozzle 400 may primarily supply beer to the beer glass, and the second beer supply nozzle 410 may secondarily supply beer to the beer glass. The first beer supply nozzle 400 may fill about 50 percent of the beer glass with beer. The second beer supply nozzle 410 may fill the rest of the beer glass with beer.

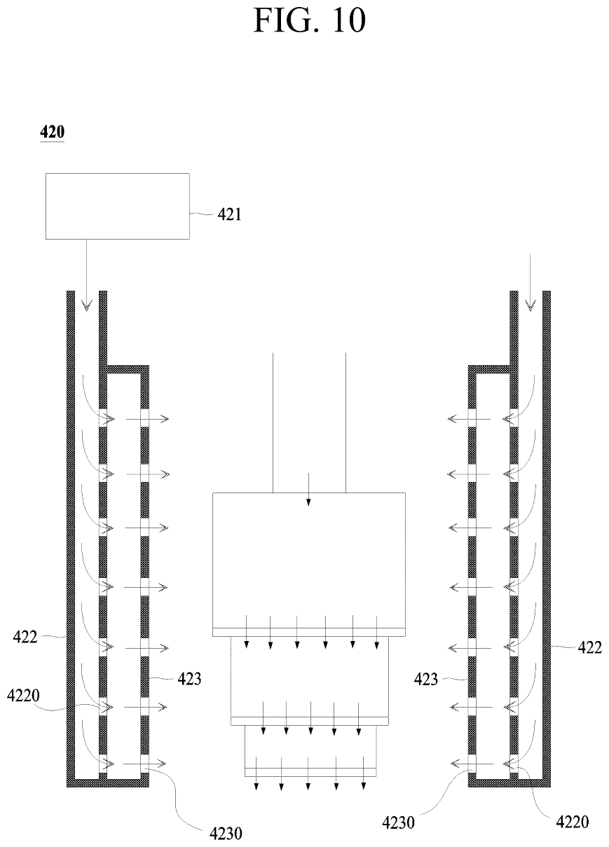

FIG. 10 is a view schematically illustrating a cold wind supply module 420 according to an embodiment of the present invention.

Referring to FIG. 10, the cold wind supply module 420 may surround the beer supply nozzle 40. The cold wind supply module 420 may include a cold wind supply portion 421, a first cold wind pipe 422, and a second cold wind pipe 423. The cold wind supply portion 421 may supply cold wind to the first cold wind pipe 422. The first cold wind pipe 422 may have a plurality of first holes 4220. The second cold wind pipe 423 may have a plurality of second holes 4230. The cold wind may flow from an upper portion of the first cold wind pipe 422 to a lower portion of the first cold wind pipe 422 and pass through the plurality of first holes 4220. Subsequently, the cold wind may be diffused inside the second cold wind pipe 423 and then discharged toward the beer supply nozzle 40 through the plurality of second holes 4230. Thus, cold wind of the same temperature may be supplied to the beer supply nozzle 40 from all of the second holes, which prevents a temperature difference at ends of the beer supply nozzle 40.

The invention devised by the present inventor are described in detail using the embodiments. However, the present invention is not limited to the embodiments above and may be modified within the gist of the present invention.

What is claimed is:

1. An apparatus of supplying frosted beer aged at low temperature, comprising:
a walk-in freezer including an internal space therein and configured to accommodate a draft beer container in the internal space;
a first controller configured to control an internal temperature of the walk-in freezer;
a gas supply portion connected to the draft beer container and configured to supply carbon dioxide to the draft beer container; and
a plurality of beer supply nozzles disposed at an outer side of the walk-in freezer and connected to the draft beer container and a beer supply pipe,
wherein a first beer supply nozzle in the plurality of the beer supply nozzles is configured to supply a beer from the draft beer container toward a lower face of a beer glass, and
a second beer supply nozzle in the plurality of the beer supply nozzles is configured to supply the beer from the draft beer container toward an inner face of the beer glass.

2. The apparatus of claim 1, wherein the first beer supply nozzle includes:
a housing connected to the beer supply pipe; and
a plurality of distribution plates disposed inside the housing and including a plurality of through holes.

3. The apparatus of claim 2, wherein the plurality of the distribution plates are arranged to vertically face each other.

4. The apparatus of claim 1, wherein the second beer supply nozzle includes:
a main injection portion configured to communicate with the beer supply pipe; and
a plurality of auxiliary injection portions configured to communicate with at least one of the beer supply pipe or the main injection portion and surround the main injection portion.

5. The apparatus of claim 4, wherein the plurality of auxiliary injection portions includes:
an auxiliary injection nozzle configured to direct the beer; and
an angle adjustment module configured to adjust an injection angle of the auxiliary injection nozzle.

6. The apparatus of claim 1, wherein the first beer supply nozzle is configured to primarily supply the beer to the beer glass, and the second beer supply nozzle is configured to secondarily supply the beer to the beer glass.
